(19) United States
(12) Patent Application Publication
(10) Pub. No.: US 2021/0066833 A1
(43) Pub. Date: Mar. 4, 2021

(54) PRINTED-CIRCUIT BOARD CONNECTOR FOR HIGH-CURRENT TRANSMISSION

(71) Applicant: HARTING ELECTRIC GMBH & CO. KG, Espelkamp (DE)

(72) Inventor: Wilhelm KLIEVER, Minden (DE)

(21) Appl. No.: 16/960,848

(22) PCT Filed: Jan. 8, 2019
(86) PCT No.: PCT/DE2019/100009

§ 371 Date: Jul. 8, 2020

(30) Foreign Application Priority Data
Jan. 26, 2018 (DE) 10 2018 101 792.8

(51) Int. Cl. H01R 12/72; H01R 12/73; H01R 12/58; H01R 12/52; H01R 12/70

(52) U.S. Cl. CPC H01R 12/721; H01R 12/737; H01R 12/7088; H01R 12/523; H01R 12/58

(57) ABSTRACT

Disclosed is a connector for forming a high-current connection between two printed circuit boards that are arranged at right angles to one another. For this purpose, a slit pin contact is provided.

### DESCRIPTION

The invention is based on a printed-circuit board connector according to the genus of independent claim 1.

Furthermore, the invention is based on an arrangement according to the genus of claim 9.

Printed circuit board connectors of this type are required in order to electrically connect two printed circuit boards to one another which are arranged perpendicular to one another and thus also to make it possible to transmit high currents >10 amperes. In particular, this can be important when constructing electrical apparatuses if, for example, a first printed circuit board is guided perpendicular to a front surface of the housing, in order to be connected to this front surface via a heavy current plug connection.

### PRIOR ART

Printed circuit boards and printed-circuit board connectors are known from the prior art. In principle, using electrical connectors for high currents >10 amperes between two printed circuit boards is problematic due to the geometric conditions.

In the prior art, it is particularly disadvantageous that there is no existing cost-effective and reliable heavy current connection between two printed circuit boards which are arranged perpendicular to one another.

### OBJECT DEFINITION

The object of the invention involves specifying a printed-circuit board connector as a cost-effective and reliable heavy current connection between two printed circuit boards. In this case, high currents >10 amperes are regarded as heavy current.

This object is achieved with the features of the characterizing part of independent claim 1.

Advantageous configurations of the invention are specified in the dependent claims.

For transmitting electrical power, a printed-circuit board connector is provided with high currents of more than 5 amperes, for example, preferably more than 10 amperes, in particular more than 15 amperes, i.e. of more than 20 amperes, for example. The printed-circuit board connector has at least one metallic, one-piece pin contact. In particular, one single pin contact of this type can transmit more than 5 amperes, preferably more than 10 amperes, in particular more than 15 amperes, i.e. of more than 20 amperes, for example. The pin contact possesses a connection region at a first end, with which connection region the pin contact can be soldered to a first contact region of a first printed circuit board and/or can be pressed into the first printed circuit board. Opposite, at a second end, the pin contact possesses a plug-in region with a slot, running in the direction of the first end, for mechanically fixing and for electrically contacting at least one second contact region which is arranged at the edge of a second printed circuit board.

This is particularly advantageous for automated production, since the second printed circuit board can be plugged into the slot of the at least one pin contact and can be soldered thereto.

For this purpose, the slot advantageously possesses a constant width which corresponds in particular to the thickness of the second printed circuit board.

In one preferred configuration, the pin contact can possess an axis of symmetry or a plane of symmetry, the slot running in the direction thereof. This serves to optimize the balance between material costs and stability.

The pin contact can be soldered to the first printed circuit board or can be pressed into said first printed circuit board in such a manner that the slot runs perpendicular to the first printed circuit board, so that the second printed circuit board, which is inserted into the slot, is therefore automatically oriented perpendicular to the first printed circuit board and at the same time can be electrically contacted therewith via the pin contact. This is particularly advantageous for constructing an electrical apparatus with a cuboid housing, since the printed circuit boards can in this way be guided parallel to the respective housing walls.

In one advantageous configuration, the at least one pin contact has a flange between its connection region and its plug-in region, which flange runs perpendicular to the slot, for strengthening its attachment and for orienting it on the first printed circuit board.

The connection region of the pin contact can be implemented as a solder connection. The pin contact is then a solder contact. The second printed circuit board, which is plugged into the slot, is then typically also additionally soldered to the plug-in region of the pin contact by way of its second contact region.

In a different configuration, the connection region of the pin contact can be implemented using press-in technology. The pin contact is then a press-in contact which possesses a corresponding through-opening in its plug-in region perpendicular to the plug-in direction. The second printed circuit board is then typically simply plugged into the slot of the pin contact by way of its second contact, in order to produce the desired electrical contact region with the first printed circuit board.

Combinations are of course also possible in which, for example, a press-in contact is additionally soldered to the first printed circuit board or in which a solder contact is also plugged into a contact bore of the first printed circuit board and is soldered thereto. Furthermore, a solder contact can also be combined with a second printed circuit board which is simply plugged into the slot (and not soldered thereto). The latter variant can serve to make it possible to be able to exchange the second printed circuit board for a different printed circuit board in a flexible manner, for example.

In particular, the pin contact can be a rotating part, in other words it is produced by a so-called “rotation”. This has the advantage that the pin contact can be produced in a solid, stable and relatively cost-effective manner.

One arrangement has at least the following:
the first printed circuit board, which possesses at least the first electrical contact region;
the second printed circuit board, which possesses at least the second and a third electrical contact region which are connected to one another in an electrically conductive manner via a conductor track of the second printed circuit board;
the printed-circuit board connector for electrically connecting the first contact region to the second contact region.

In this case, the second printed circuit board can be plugged into the slot of the pin contact and thus be soldered to the second contact region thereof. This has the advantage that the second printed circuit board can be fixed to the pin contact and thus can be contacted with only little effort, in particular in an automated manner. As a result, the second printed circuit board can be mechanically fixed to the first printed circuit board and at the same time possess at least one electrically conductive connection to the first printed circuit board.

Furthermore, the arrangement can possess an in particular cuboidal apparatus housing in which the two printed circuit boards are arranged. In this case, the first printed circuit board can be oriented perpendicular to a front side of the apparatus housing and the second printed circuit board can run parallel to the front side. This has the advantage that the installation space which is available in the apparatus is particularly well utilized.

The front side of the apparatus housing can possess a through-opening as well as a plug connector housing which is affixed thereto. This is advantageous in order to supply the printed circuit boards with electrical power.

A contact carrier with at least one plug contact located therein can be attached to the second printed circuit board for this purpose.

The plug contact can be fixed to the third contact region of the second printed circuit board in an electrically conductive manner on one side and project into the plug connector housing at the plug-in side. This has the advantage that electrical power can be inserted into the apparatus and can be internally transmitted from the second printed circuit board to the first printed circuit board.

Advantageously, the plug contact can project into the plug connector housing at the plug-in side. This serves to make plugging with an external mating plug possible. The external mating plug is typically a socket plug with socket contacts, since current-carrying parts in the region of the heavy current transmission cannot be freely accessible for reasons of safety. For this reason, the corresponding plug contacts which are connected to the second printed circuit board are preferably corresponding pin contacts.

In particular, the plug contact can be a heavy current contact which is suitable for transmitting currents of at least 10 amperes per contact. This has the advantage that the second printed circuit board and moreover also the first printed circuit board can be supplied with correspondingly high currents. In particular, although it runs perpendicular to the front surface in which the plug connector housing is arranged, the first printed circuit board can be supplied with these high currents.

In one preferred configuration, the second printed circuit board, in addition to said fixing by way of the at least one contact pin, can be additionally attached via a support element on the first printed circuit board and/or by means of a screw connection on the front side of the apparatus housing, in order to resist the plug forces of the plug contact and in particular to keep away the corresponding leverage forces from the pin contacts.

### EXEMPLARY EMBODIMENT

An exemplary embodiment of the invention is depicted in the drawings and is explained in greater detail hereinafter. In the drawings:

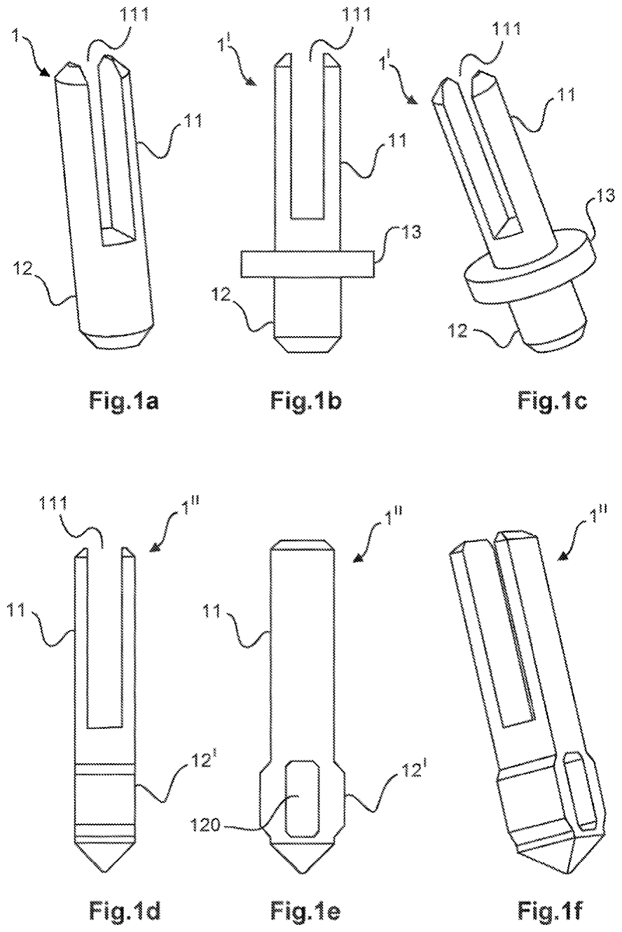

FIGS. 1a-c show the pin contact as a solder contact without and with a flange;

FIGS. 1d-f show the pin contact using press-in technology

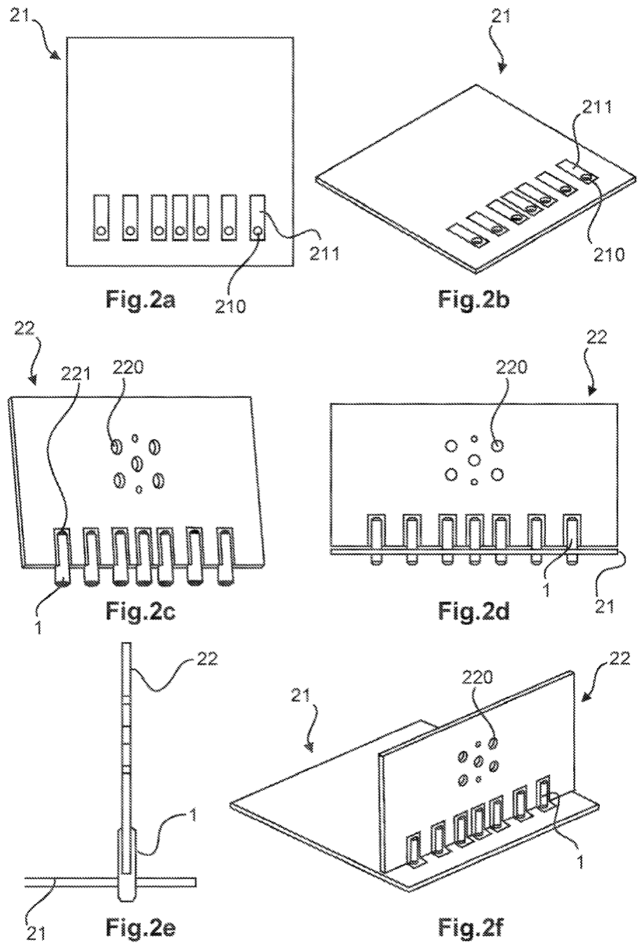

FIGS. 2a-f show a first arrangement of a first and a second printed circuit board and a printed-circuit board connector with solder connections;

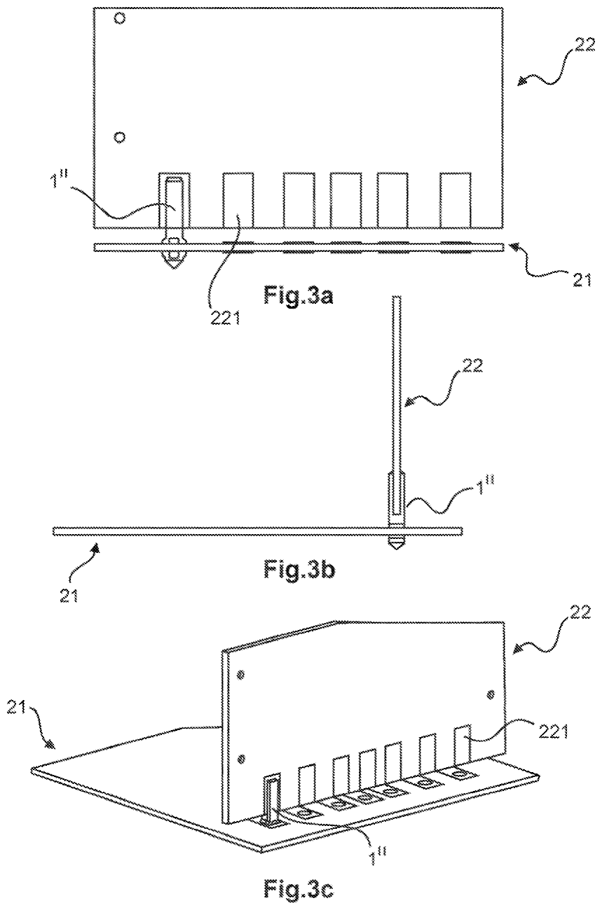

FIGS. 3a-c show a second arrangement of a first and a second printed circuit board and a printed-circuit board connector using press-in technology;

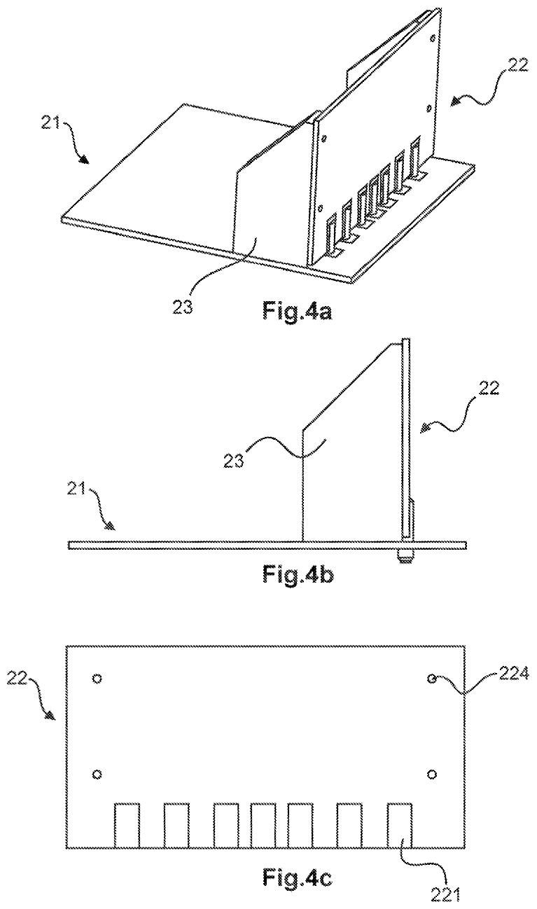

FIGS. 4a, b show the first arrangement with a support element;

FIG. 4c shows the second printed circuit board with perforations for attaching to a front side of an apparatus housing.

The figures contain partially simplified, schematic depictions. Identical reference numbers are partly used for the same but not necessarily identical elements. Different views of the same elements could be scaled differently.

FIG. 1a shows a pin contact 1 which is implemented as a solder contact. This pin contact 1 possesses a cylindrical basic shape. The pin contact possesses a connection region 12 at a first end, which connection region can be soldered to a first contact region 211 of a first printed circuit board 21.

The pin contact 1 possesses a plug-in region 11 at a second end which is opposite the first end. The pin contact 1 possesses a slot 111 in the plug-in region 11. This slot 111 is suitable for receiving a second contact region 221 of a second printed circuit board 22 in a form-fitting and force-fitting manner, which is shown in FIGS. 2a and 2b.

FIGS. 1b and 1c show a similar pin contact 1″ which only differs from the previous pin contact 1 in that it additionally possesses a circumferential flange 13 which is arranged between its plug-in region 11 and its connection region 12. This flange 13 serves to additionally support and stabilize the soldered pin contact 1′ on the first printed circuit board 21. In this case, the connection region 12 of the pin contact 1 is plugged through a contact bore 210 of the first contact region 211 of the first printed circuit board 21. This is not absolutely necessary for soldering, but it does ensure a higher degree of stability in the present case.

FIGS. 1d-f show a further pin contact 1″ in a second embodiment, namely as a press-in contact. The basic shape of this further pin contact 1″ is substantially cuboidal. Its connection region is tapered toward the first end and possesses a through-opening 120. It is thus implemented using press-in technology and can electrically contact the first printed circuit board 21 by way of the contact bore 210, without a soldering process being necessary for this purpose. The connection region 1 of the further pin contact 1″ also possesses said slot 111 for receiving the second contact region 221 of the second printed circuit board 22 and differs from that of the aforementioned pin contacts 1,1″ only by said cuboidal basic shape. The pin contacts shown are made in one piece and consist of metal.

As already indicated, FIGS. 2a and 2b show a plan view and an oblique view of the first printed circuit board. In this case, no conductor tracks are shown, although these can of course exist. However, the first contact regions 211 as well as the associated contact bores 210 are clearly visible.

FIG. 2c shows a slightly oblique view of the second printed circuit board 22, wherein it is already inserted into the slot 111 of the plug-in regions 11 of the plug contacts 1 by way of its second contact regions 221. These contact regions can additionally optionally be soldered to the plug-in regions.

FIGS. 2d-f show an arrangement having the first printed circuit board 21, the second printed circuit board 22 and pin contacts 1 in the plugged-together and soldered state. It is readily apparent that the pin contacts 1 are guided through the contact bores 210 of the first printed circuit board 21 on the connection side. In addition, the connection regions 12 of the pin contacts 1 are soldered to the first contact regions 211 of the first printed circuit board 21. The second printed circuit board 22 is plugged into the slot 111 of the plug-in regions 11 of the pin contacts 1 by way of its second contact regions 221. Said second printed circuit board can therefore be exchanged for a different second, possibly slightly differently assembled, printed circuit board at any time, with little effort. However, this specific assembly is not essential for understanding the present invention and is therefore not shown.

Furthermore, it is easily recognizable that the two printed circuit boards 21, 22 are perpendicular to one another as a result of the pin contacts 1.

Moreover, the second printed circuit board 22 possesses plug contact bores 220 which are connected to at least some of the second contact regions 221 by way of third contact regions, which are not depicted in the drawing, via conductor tracks, which are not shown. These plug contact bores 220 serve to introduce and contact plug contacts which are not shown.

FIGS. 3a- 3c show a similar arrangement with the pin contacts 1′ which are implemented using press-in technology. In the present case, they are therefore not soldered to the first printed circuit board 21 but rather produce the electrical contact with the first contact regions by simply plugging their connection regions into the contact bores 210.

FIGS. 4a- 4c show structures which serve to relieve the respective pin contact 1, 1′, 1″ of the mechanical plug forces which act on the second printed circuit board 22.

FIGS. 4a and 4b show two support elements which attach the second printed circuit board to the first printed circuit board on both sides.

Alternatively or additionally, the second printed circuit board 22 can also have attachment bores 224, as shown in FIG. 4c. Using these attachment bores 224, said second printed circuit board can be screwed to the front side of the apparatus housing, which is not shown, using screw bolts or long screws, for example, and can therefore be fixed thereto in a stable manner. As a result, the pin contacts 1, 1′, 1″ are relieved of plug forces which act on the second printed circuit board 22.

Even if different aspects or features of the invention are each shown in combination in the figures, it is clear to a person skilled in the art—unless otherwise specified—that the combinations depicted and discussed are not the only possible combinations. In particular, mutually corresponding units or feature complexes from different exemplary embodiments can be exchanged with one another.

### LIST OF REFERENCE NUMBERS

1, 1′, 1″ Pin contact

11 Plug-in region

111 Slot

12, 12′ Connection region

120 Through-opening

13 Flange

21 First printed circuit board

210 Contact bore

211 First contact region

22 Second printed circuit board

220 Plug contact bores

221 Second contact region

23 Support element

1. A printed-circuit board connector for transmitting electrical power with high currents, wherein the printed-circuit board connector has at least one metallic, one-piece pin contact, wherein the pin contact possesses a connection region at a first end, with which connection region the pin contact is configured to be soldered to a first contact region of a first printed circuit board and/or to be pressed into the first printed circuit board at the first contact region, and wherein the pin contact, opposite at a second end, possesses a plug-in region with a slot, running in the direction of the first end, configured for mechanically fixing and for electrically contacting at least one second contact region which is arranged at the edge of a second printed circuit board.

2. The printed-circuit board connector as claimed in claim 1, wherein the slot possesses a constant width.

3. The printed-circuit board connector as claimed in claim 1, wherein the pin contact possesses an axis of symmetry or a plane of symmetry, the slot running in the direction thereof.

4. The printed-circuit board connector as claimed in claim 1, wherein the pin contact is configured to be soldered to the first printed circuit board and/or to be pressed into the printed circuit board in such a manner that the slot runs perpendicular to the first printed circuit board, so that the second printed circuit board, which is inserted into the slot, is therefore automatically oriented perpendicular to the first printed circuit board and at the same time is configured to be electrically contacted therewith via the pin contact.

5. The printed-circuit board connector as claimed in claim 1, wherein the at least one pin contact has a flange between its connection region and its plug-in region, which flange runs perpendicular to the slot, for strengthening its attachment and for orienting it on the first printed circuit board.

6. The printed-circuit board connector as claimed in claim 1, wherein the connection region of the at least one pin contact is implemented as a solder connection.

7. The printed-circuit board connector as claimed in claim 1, wherein the connection region of the at least one pin contact is implemented using press-in technology.

8. The printed-circuit board connector as claimed in claim 1, wherein the pin contact is a rotating part.

9. An arrangement which has at least the following:
the first printed circuit board, which possesses at least the first electrical contact region;
the second printed circuit board, which possesses at least the second and a third electrical contact region which are connected to one another in an electrically conductive manner via a conductor track of the second printed circuit board; and
the printed-circuit board connector as claimed in one of the preceding claims for electrically connecting the first contact region to the second contact region.

10. The arrangement as claimed in claim 9, wherein the second printed circuit board is plugged into the slot of the at least one pin contact by way of its at least one second contact region, in order to produce a mechanical fixing to and an electrically conductive connection to the first printed circuit board.

11. The arrangement as claimed in claim 10, wherein the second printed circuit board is additionally also soldered to the connection region of the at least one pin contact by way of its at least one second contact region.

12. The arrangement as claimed in claim 9,
wherein the arrangement further possesses an apparatus housing in which the two printed circuit boards are arranged,
wherein the first printed circuit board is oriented perpendicular to a front side of the apparatus housing,
wherein the second printed circuit board runs parallel to the front side,
wherein the front side possesses a through-opening as well as a plug connector housing which is affixed thereto,
wherein a contact carrier with at least one plug contact located therein is attached to the second printed circuit board,
wherein the plug contact is fixed to the third contact region of the second printed circuit board in an electrically conductive manner on one side and projects into the plug connector housing at the plug-in side.

13. The arrangement as claimed in claim 11, wherein the plug contact is a heavy current contact which is configured for transmitting currents of more than 10 amperes.

14. The arrangement as claimed in claim 1, wherein the second printed circuit board is additionally attached via a support element on the first printed circuit board and/or a screw connection on the front side of the apparatus housing, in order to resist the plug forces of the plug contact.

15. The arrangement as claimed in claim 12, wherein the second printed circuit board is additionally attached via a support element on the first printed circuit board and/or a screw connection on the front side of the apparatus housing, in order to resist the plug forces of the plug contact.
